(19) United States
(12) Patent Application Publication
(10) Pub. No.: US 2025/0111720 A1
(43) Pub. Date: Apr. 3, 2025

(54) MULTI-COLOR KEYPAD FOR ELECTRONIC LOCKS

(71) Applicant: ASSA ABLOY Americas Residential Inc., New Haven, CT (US)

(72) Inventors: Kevin Pasma, Lake Forest, CA (US); Matthew Denton Lovett, Rancho Santa Margarita, CA (US); Elliott Schneider, Foothill Ranch, CA (US)

(21) Appl. No.: 18/899,658

(22) Filed: Sep. 27, 2024

Related U.S. Application Data
(60) Provisional application No. 63/586,485, filed on Sep. 29, 2023.

(51) Int. Cl. G07C 9/00

(52) U.S. Cl. CPC G07C 9/00944; G07C 9/00309; G07C 9/00571; G07C 2009/00587; G07C 2009/00769; G07C 2209/62

(57) ABSTRACT

A multi-color keypad for electronic locks is provided. Lighting elements illuminate keypad regions of the keypad in any of a plurality of colors. The lighting elements illuminate in accordance with a presentation mode to display defined colors and animations. Presentation modes may define, for example, status messages to be displayed, color-based passcode input processes, and ornamental displays. The presentation modes may be customized to change the colors and animations displayed in the presentation modes.

### CROSS-REFERENCE TO RELATED APPLICATIONS

This application claims priority to U.S. Provisional Patent Application No. 63/586,485 filed Sep. 29, 2023, the disclosure of which is incorporated herein by reference in its entirety.

### BACKGROUND

Keypads may be used with electronic locks as a means of securing premises. By entering a valid actuation passcode at the keypad, the electronic lock actuates to lock/unlock a door at the premises. The keypad may illuminate to provide feedback to users; however, this information is limited. For example, a keypad may be configured to illuminate during low-light scenarios, or may flash to indicate entry of a valid, or invalid, actuation passcode. There are only a limited number of ways in which such a display may illuminate, in particular, which are recognizable to a user, and which convey status of the lock. Furthermore, such keypad configurations with limited illumination capabilities may not be aesthetically pleasing to a user, or offer little additional aesthetic value.

### SUMMARY

In general terms, this disclosure is directed to a multi-color keypad for electronic locks. In some embodiments, and by non-limiting example, lighting elements illuminate predefined keypad regions in the keypad in any of a plurality of colors. The illumination of the predefined keypad regions may be in accordance with a presentation mode.

In an aspect, an electronic lock is provided. The electronic lock comprises a processing unit, a memory device, and a keypad. The memory device stores instructions defining a plurality of presentation modes. The keypad comprises a plurality of predefined keypad regions. Each predefined keypad region includes one or more lighting elements. In response to receiving a signal from the processing unit, the one or more lighting elements illuminate the predefined keypad region in any of a plurality of colors in accordance with a selected one of the plurality of presentation modes.

In another aspect, a method for illuminating a keypad is provided. A presentation mode is selected from a plurality of stored presentation modes. One or more signals are sent from a processing unit to one or more lighting elements based on the selected presentation mode. One or more predefined keypad regions are illuminated in any of a plurality of colors by the one or more lighting elements based on the received one or more signals.

In a further aspect, a system for managing electronic lock settings is provided. The system includes an electronic lock and a computing device. The electronic lock includes a processing unit, a memory device, and a keypad. The memory device stores instructions defining a plurality of presentation modes. The keypad comprises a plurality of predefined keypad regions. Each predefined keypad region includes one or more lighting elements. In response to receiving a signal from the processing unit, the one or more lighting elements illuminate the predefined keypad region in any of a plurality of colors in accordance with a selected one of the plurality of presentation modes. The computing device includes a processor and a memory device. The memory device stores instructions that, when executed by the processor, cause the computing device to execute an electronic lock application. The electronic lock application includes options for customizing at least one of the plurality of presentation modes.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a side view of a portion of an electronic lock installed at a door.

FIG. 2 illustrates a rear perspective view of a portion of the electronic lock shown in FIG. 1.

FIG. 3 illustrates a front perspective of a portion of the electronic lock shown in FIG. 1.

FIG. 4 illustrates a schematic representation of the electronic lock shown in FIG. 1.

FIG. 5 illustrates an environment in which aspects of the present disclosure may be implemented.

FIG. 6 illustrates a schematic representation of a mobile device seen in the environment shown in FIG. 5.

FIG. 7 illustrates a pictorial representation of a mobile device executing an electronic lock application that provides a user interface for customizing settings of an electronic lock.

FIG. 8 illustrates a pictorial representation of a mobile device executing an electronic lock application that provides a second user interface for customizing settings of an electronic lock.

FIG. 9 illustrates a pictorial representation of a mobile device executing an electronic lock application that provides a third user interface for customizing settings of an electronic lock.

FIG. 10 illustrates a pictorial representation of a mobile device executing an electronic lock application that provides a fourth user interface for customizing settings of an electronic lock.

FIG. 11 illustrates an example embodiment of a keypad.

FIG. 12 illustrates an example of a circuit in the keypad shown in FIG. 11.

FIGS. 13A-C illustrates an example of a keypad illuminating according to a presentation mode.

FIG. 14 illustrates a flowchart of an example method for illuminating a keypad according to a presentation mode.

FIGS. 15A-D illustrates a second example of a keypad illuminating according to a presentation mode.

FIGS. 16A-D illustrates a third example of a keypad illuminating according to a presentation mode.

FIG. 17 illustrates a flowchart of a second example method for illuminating a keypad according to a presentation mode.

FIGS. 18A-B illustrates a fourth example of a keypad illuminating according to a presentation mode.

FIG. 19 illustrates a flowchart of a third example method for illuminating a keypad according to a presentation mode.

FIGS. 20A-E illustrates a fifth example of a keypad illuminating according to a presentation mode.

FIGS. 21A-F illustrates a sixth example of a keypad illuminating according to a presentation mode.

FIGS. 22A-F illustrates a seventh example of a keypad illuminating according to a presentation mode.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As briefly described above, the present disclosure is directed to a multi-color keypad for an electronic lock. In example aspects, a keypad for an electronic lock includes a plurality of predefined keypad regions, each with associated lighting elements. In response to signals from a processing unit in the electronic lock, the lighting elements illuminate the keypad regions in any of a plurality of selectable colors.

In further aspects, the lighting elements illuminate in accordance with different presentation modes. In an example, the presentation mode is used to provide information about a status of the electronic lock to the user. For example, the lighting elements may illuminate in a colored arrangement to indicate a battery level of the electronic lock. In another example, the lighting elements may illuminate in a different colored arrangement to indicate that a mobile device is pairing with the electronic lock. Because the lighting elements in the keypad may illuminate in any of a plurality of colors, more types of feedback may be provided to the user through illumination of the lighting elements.

In another example, the presentation mode is for a passcode input process to lock or unlock the electronic lock. For example, a passcode associated with the electronic lock may include numbers and/or colors, or a combination thereof. Some or all of the lighting elements may illuminate in a different color such that, while all keypad regions are associated with a number, some or all of the keypad regions may also be associated with a color. The lighting elements may illuminate different colors in different keypad positions during different passcode input processes, such that regions of the keypad associated with different numbers or symbols may be illuminated in different colors during the different passcode input processes. Such changes in color may encourage a user to select different keypad regions to enter a passcode that includes a specific color. By changing the keypad regions with which a user interacts during a passcode input process, the keypad regions may wear more evenly, as compared to circumstances in which the user interacts with the same keypad regions during each passcode input process. This may make it more difficult for unauthorized users to guess the passcode associated with the electronic lock based on the wear of the keypad regions.

In another example, the presentation mode may be ornamental. For example, the lighting elements may illuminate in a predefined pattern to display an animation on the keypad.

In further example aspects, users may modify the presentation modes to change the appearance of the keypad when the lighting elements are illuminated. This allows greater customization of the keypad and allows the keypad to display different colors and/or animations depending on the preferences of a user. Such different presentation modes may improve the aesthetic appearance of the keypad and electronic lock overall.

The term “lock” or “lockset” is broadly intended to include any type of lock, including, but not limited to, deadbolts, knob locks, lever handle locks, mortise locks, and slide locks, whether mechanical, electrical, or electro-mechanical locks. The locking points may have various mounting configurations and/or locations, including, but not limited to, mortised within the doorframe, mounted externally to the doorframe or support structure, and/or affixed directly to the door.

Although this disclosure describes these features as implemented on an electronic deadbolt lock for purposes of example, these features are applicable to any type of lockset, including but not limited to, deadbolts, knobset locks, handleset locks, etc. Still further, example aspects of the present application can be applied to other types of IoT devices for which security is an issue, e.g., wireless/interconnected home devices that store user data.

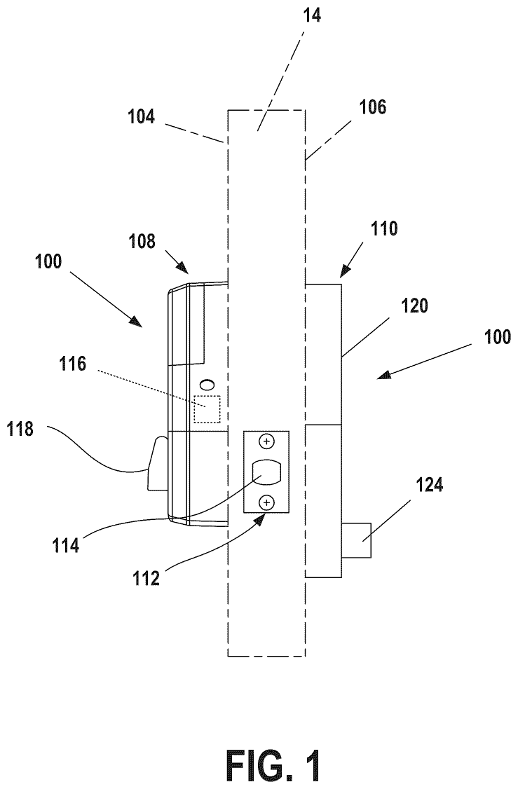

FIGS. 1-3 illustrate an electronic lock 100 as installed at a door 14 according to one example of the present disclosure in which such a keypad arrangement may be implemented. In this example, the door 14 has an interior side 104 and an exterior side 106. The electronic lock 100 includes an interior assembly 108, an exterior assembly 110, and a latch assembly 112. The latch assembly 112 is shown to include a bolt 114 that is movable between an extended position (locked) and a retracted position (unlocked, shown in FIGS. 1-3). Specifically, the bolt 114 is configured to slide longitudinally and, when the bolt 114 is retracted, the door 14 is in an unlocked state. When the bolt 114 is extended, the bolt 114 protrudes from the door 14 into a doorjamb (not shown) to place the door in a locked state.

In some examples, the interior assembly 108 is mounted to the interior side 104 of the door 14, and the exterior assembly 110 is mounted to the exterior side 106 of the door 14. The latch assembly 112 is typically at least partially mounted in a bore formed in the door 14. The term “outside” is broadly used to mean an area outside the door 14 and “inside” is broadly used to denote an area inside the door 14. With an exterior entry door, for example, the exterior assembly 110 may be mounted outside a building, while the interior assembly 108 may be mounted inside a building. With an interior door, the exterior assembly 110 may be mounted inside a building, but outside a room secured by the electronic lock 100, and the interior assembly 108 may be mounted inside the secured room. The electronic lock 100 is applicable to both interior and exterior doors.

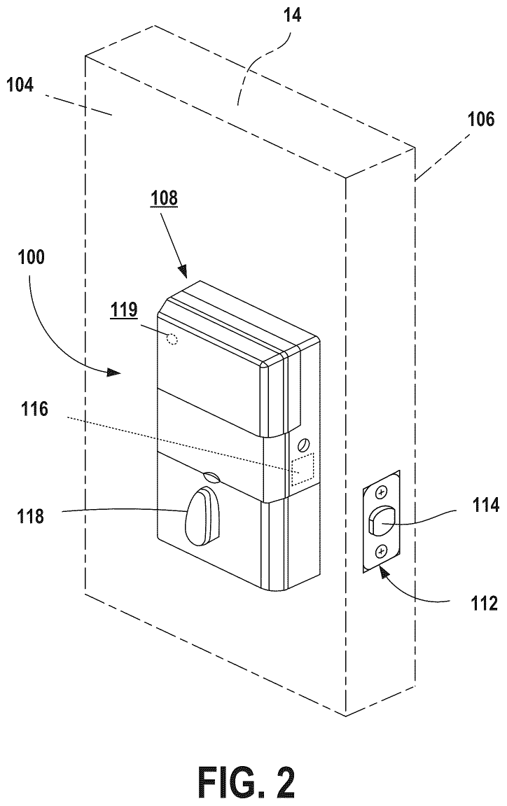

Referring to FIG. 2, the interior assembly 108 can include a processing unit 116 (shown schematically) containing electronic circuitry for the electronic lock 100. In some examples, the interior assembly 108 includes a manual turn piece 118 that can be used on the interior side 104 of door 14 to move the bolt 114 between the extended and retracted positions, as well as an interior sensor 119, such as any of the sensor types noted below. The processing unit 116 is operable to execute a plurality of software instructions (i.e., firmware) that, when executed by the processing unit 116, cause the electronic lock 100 to implement the methods and otherwise operate and have functionality as described herein. The processing unit 116 may comprise a device commonly referred to as a processor, e.g., a central processing unit (CPU), digital signal processor (DSP), or other similar device, and may be embodied as a standalone unit or as a device shared with components of the electronic lock 100. The processing unit 116 may include memory communicatively interfaced to the processor, for storing the software instructions. Alternatively, the electronic lock 100 may further comprise a separate memory device for storing the software instructions that is electrically connected to the processing unit 116 for the bi-directional communication of the instructions, data, and signals therebetween.

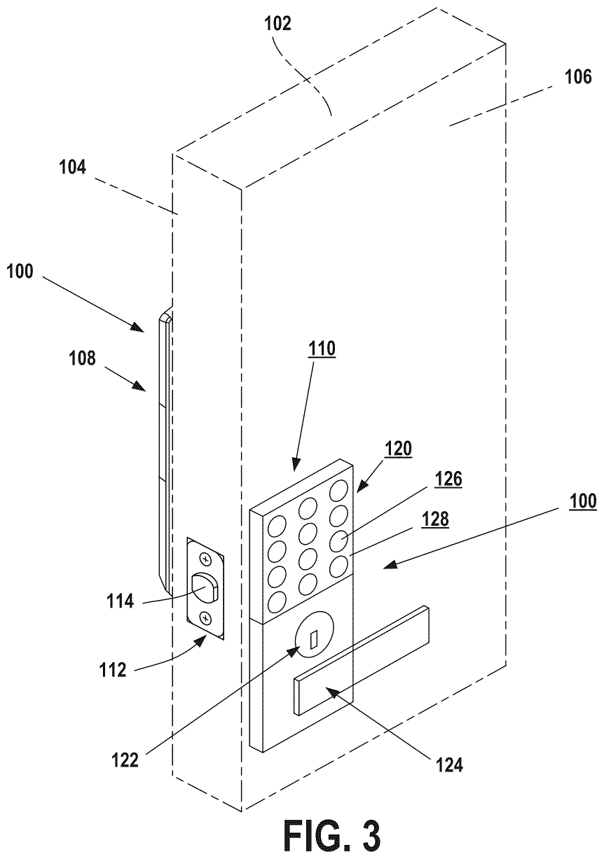

Referring to FIG. 3, the exterior assembly 110 can include exterior circuitry communicatively and electrically connected to the processing unit 116. For example, the exterior assembly 110 can include a keypad 120 for receiving a user input and/or a keyway 122 for receiving a key (not shown). The exterior side 106 of the door 14 can also include a handle 124. In some examples, the exterior assembly 110 includes the keypad 120 and not the keyway 122. In some examples, the exterior assembly 110 includes the keyway 122 and the keypad 120. When a valid key is inserted into the keyway 122, the valid key can move the bolt 114 between the extended and retracted positions. When a user inputs a valid actuation passcode into the keypad 120, the bolt 114 is moved between the extended and retracted positions. In some examples, the exterior assembly 110 is electrically connected to the interior assembly 108. Specifically, the keypad 120 is electrically connected to the interior assembly 108, specifically to the processing unit 116, by, for example, an electrical cable (not shown) that passes through the door 14. When the user inputs a valid actuation passcode via the keypad 120 that is recognized by the processing unit 116, an electrical motor is energized to retract the bolt 114 of the latch assembly 112, thus permitting the door 14 to be opened from a closed position. Still further, an electrical connection between the exterior assembly 110 and the interior assembly 108 allows the processing unit 116 to communicate with other features included in the exterior assembly 110, as noted below.

The keypad 120 can be any of a variety of different types of keypads. The keypad 120 can be one of a numeric keypad, an alpha keypad, and/or an alphanumeric keypad. The keypad 120 can have a plurality of characters displayed thereon, with each character being associated with a predefined keypad region 126. In an example, the keypad regions 126 include a plurality of buttons that can be mechanically actuated by the user (e.g., physically pressed). In some examples, the keypad regions 126 are defined in a touch interface 128, such as a touch screen or a touch keypad, for receiving a user input. The touch interface 128 is configured to detect a user's “press of a button” by contact without the need for pressure or mechanical actuation. An example of the touch interface is described in U.S. Pat. No. 9,424,700 for an “ELECTRONIC LOCK HAVING USAGE AND WEAR LEVELING OF A TOUCH SURFACE THROUGH RANDOMIZED CODE ENTRY,” which is hereby incorporated by reference in its entirety.

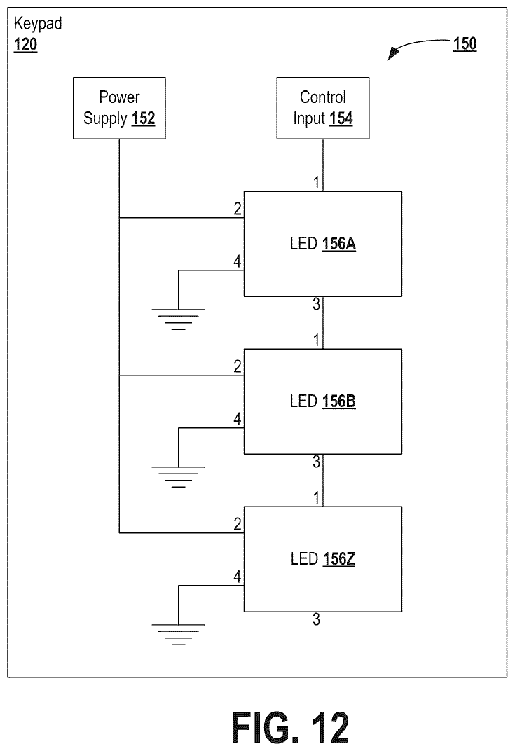

The keypad 120 may also include one or more lighting elements 156 (shown in FIG. 12) to illuminate the keypad regions 126. The lighting elements 156 may illuminate the keypad 120 in accordance with a presentation mode. As described further herein, the lighting elements 156 may illuminate the keypad 120 in accordance with a presentation mode to provide information on the status of the electronic lock 100, enable a color-based passcode input process, or create an ornamental display.

In alternative embodiments, one or more other types of user interface devices can be incorporated into the electronic lock 100. For example, in example implementations, the exterior assembly 110 can include a biometric interface (e.g., a fingerprint sensor, retina scanner, or camera including facial recognition), or an audio interface by which voice recognition could be used to actuate the lock. Still further, other touch interfaces may be implemented, e.g., where a single touch may be used to actuate the lock rather than requiring entry of a specified actuation passcode.

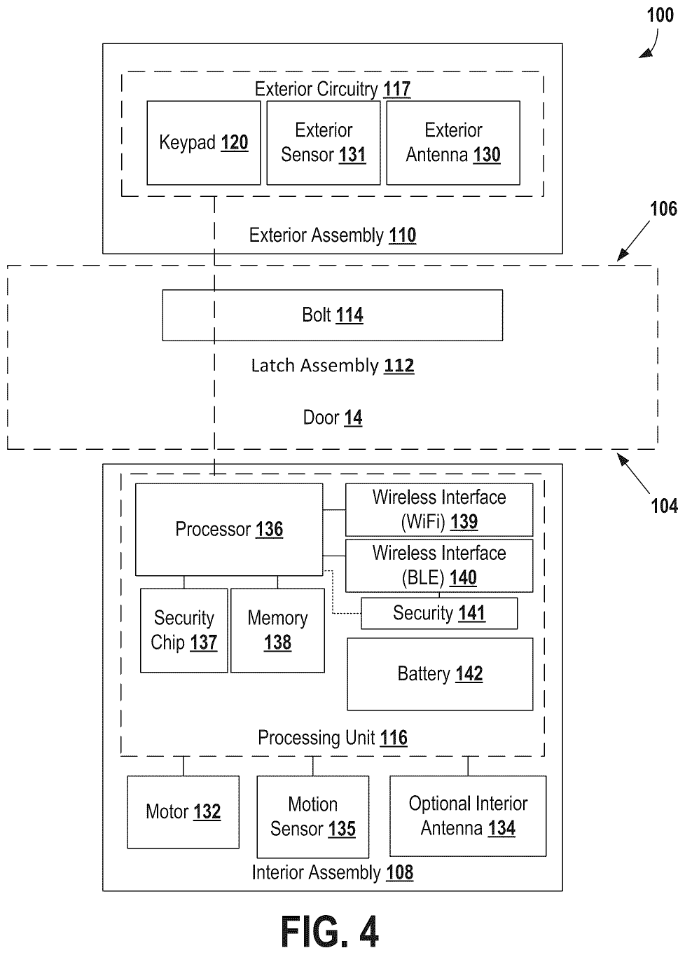

FIG. 4 shows a schematic representation of the electronic lock 100 mounted to the door 14. The interior assembly 108, the exterior assembly 110, and the latch assembly 112 are shown.

The exterior assembly 110 is shown to include exterior circuitry 117, which may include the keypad 120 and an optional exterior antenna 130 usable for communication with a remote device. In some examples, the exterior antenna 130 includes an antenna array of a plurality of antennas usable to detect or determine position of a remote device in wireless communication with the electronic lock 100. In addition, the exterior assembly 110 can include one or more sensors 131, such as a camera, proximity sensor, or other mechanism by which conditions exterior to the door 14 can be sensed. In response to sensed conditions, a signal may be sent to illuminate the keypad, as described further herein.

The exterior antenna 130 is capable of being used in conjunction with an interior antenna 134, such that the processing unit 116 can determine where a mobile device is located. Only a mobile device that is paired with the electronic lock 100 and determined to be located on the exterior of the door 14 is able to actuate (unlock or lock) the door 14. This prevents unauthorized users from being located exterior to the door 14 of the electronic lock 100 and taking advantage of an authorized mobile device that may be located on the interior of the door 14, even though that authorized mobile device is not being used to actuate the door 14. However, such a feature is not required, but can add additional security. In alternative arrangements, the electronic lock 100 is only actuatable from either the keypad 120 (via entry of a valid actuation passcode) or from an application installed on the mobile device. In such arrangements, because touch alone at the exterior of the door 14 cannot actuate the lock 100, the exterior antenna 130 may be excluded entirely.

As described above, the interior assembly 108 includes the processing unit 116. The interior assembly 108 can also include a motor 132 and an optional interior antenna 134.

As shown, the processing unit 116 includes at least one processor 136 communicatively connected to a security chip 137, a memory 138, various wireless communication interfaces (e.g., including a Wi-Fi interface 139 and/or a Bluetooth interface 140), and a battery 142. The processing unit 116 is located within the interior assembly 108 and is capable of operating the electronic lock 100, e.g., by actuating the motor 132 to actuate the bolt 114.

In some examples, the processor 136 can process signals received from a variety of devices to determine whether the electronic lock 100 should be actuated. Such processing can be based on a set of preprogramed instructions (i.e., firmware) stored in the memory 138. In certain embodiments, the processing unit 116 can include a plurality of processors 136, including one or more general purpose or specific purpose instruction processors. In some examples, the processing unit 116 is configured to capture a keypad input event from a user and store the keypad input event in the memory 138. In other examples, the processor 136 receives a signal from the exterior antenna 130, the interior antenna 134, or a motion sensor 135 (e.g., a vibration sensor, gyroscope, accelerometer, motion/position sensor, or combination thereof) and can validate received signals in order to actuate the lock 100. In still other examples, the processor 136 receives signals from the Bluetooth interface 140 to determine whether to actuate the electronic lock 100.

In further examples, the processor 136 selects presentation modes for the keypad 120. In examples, the presentation modes are used to display a status message, initiate a color-based passcode input process, and show ornamental displays on the keypad 120. In other examples, presentation modes may be defined for any situation in which it is beneficial to illuminate the keypad 120. In some embodiments, the processor 136 receives signals from other components of the electrical lock 100 and selects a presentation mode based on the signals. In an example, the exterior sensor 131 detects a user proximate to the keypad 120 and sends a signal to the processor 136. In response, the processor 136 selects an ornamental presentation mode. After selecting the presentation mode, the processor 136 sends signals to lighting elements in the keypad 120 based on the presentation mode, and the lighting elements illuminate keypad regions of the keypad 120 in accordance with the presentation mode. In some embodiments, the signals sent by the processor 136 may depend on a status of the electronic lock 100 in addition to the selected presentation mode. For example, if the presentation mode is a status message presentation mode to display a battery level of the electronic lock 100, the signals sent by the processor 136 depend on the battery level of the electronic lock 100 such that the keypad 120 is illuminated differently when the battery level is high compared to when the battery level is low. Examples of keypads 120 illuminating in accordance with presentation modes are described further herein.

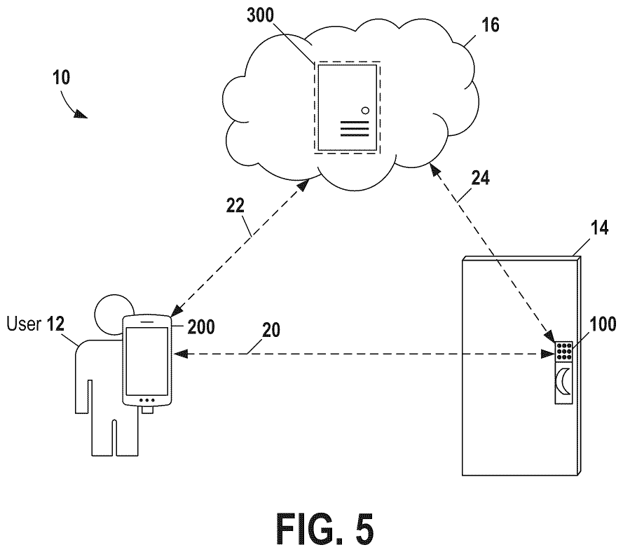

In some embodiments, the processing unit 116 includes a security chip 137 that is communicatively interconnected with one or more instances of processor 136. The security chip 137 can, for example, generate and store cryptographic information usable to generate a certificate usable to validate the electronic lock 100 with a remote system, such as a server 300 or mobile device 200 shown in FIG. 5. In certain embodiments, the security chip 137 includes a one-time write function in which a portion of memory of the security chip 137 can be written only once, and then locked. Such memory can be used, for example, to store cryptographic information derived from characteristics of the electronic lock 100, or its communication channels with server 300 or one or more mobile devices 200. Accordingly, once written, such cryptographic information can be used in a certificate generation process which ensures that, if any of the characteristics reflected in the cryptographic information are changed, the certificate that is generated by the security chip 137 would become invalid, and thereby render the electronic lock 100 unable to perform various functions, such as communicate with the server 300 or mobile device 200, or operate at all, in some cases.

In some embodiments, the security chip 137 may be configured to generate a pairing passcode that, when entered using the keypad 120 of the electronic lock 100, triggers a BLE pairing mode of the electronic lock 100 that enables the electronic lock 100 to pair with a proximate mobile device (e.g., mobile device 200 on which an electronic lock application associated with the electronic lock 100 is operating). In some examples, the pairing passcode is provided to a user 12 upon initial setup/activation of the electronic lock 100 (e.g., via an electronic lock application associated with the electronic lock 100 operating on the mobile device 200). In some examples, the pairing passcode is a random value. In some examples, the user 12 may be enabled to change the pairing passcode by setting their own code or by requesting a random value to be generated by the electronic lock application operating on the mobile device 200. In some examples, the length of the pairing passcode is variable. According to an aspect, for increased security, the pairing passcode may be a limited-use passcode. For example, the pairing passcode may be limited to a single use or may be active for a preset or user-selected time duration. In further examples, a digit of the pairing passcode may correspond to a setting that may instruct the electronic lock 100 to perform one or more of: disable the pairing passcode after it has been used; keep the pairing passcode enabled after it has been used; or reset the pairing passcode to a new random value after it has been used.

The memory 138 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices. Computer storage media can, in some examples, include embodiments including entirely non-transitory components.

In some embodiments, the memory 138 stores instructions defining a plurality of presentation modes for the keypad 120. The presentation modes may define the colors and timing for illumination of the keypad 120 during various actions. In an example, a presentation mode may define that the keypad illuminates green when a valid actuation passcode is entered and red when an invalid actuation passcode is entered. In other examples, a presentation mode defines ornamental colors and animations for the keypad 120. In further examples, a presentation mode defines illumination of the keypad 120 during passcode input processes.

As noted above, the processing unit 116 can include one or more wireless interfaces, such as Wi-Fi interface 139 and/or a Bluetooth interface 140. Other RF circuits can be included as well. In the example shown, the interfaces 139, 140 are capable of communication using at least one wireless communication protocol. In some examples, the processing unit 116 can communicate with a remote device via the Wi-Fi interface 139, or a local device via the Bluetooth interface 140. In some examples, the processing unit 116 can communicate with one or both of the mobile device 200 and server 300 via the Wi-Fi interface, and can communicate with the mobile device 200 when the mobile device 200 is in proximity to the electronic lock 100 via the Bluetooth interface 140. In some embodiments, the processing unit 116 is configured to communicate with the mobile device 200 via the Bluetooth interface 140, and communications between the mobile device 200 and electronic lock 100 when the mobile device 200 is out of range of Bluetooth wireless signals can be relayed via the server 300, e.g., via the Wi-Fi interface 139.

Of course, in alternative embodiments, other wireless protocols could be implemented as well, via one or more additional wireless interfaces. In some examples, the electronic lock 100 can wirelessly communicate with external devices through a desired wireless communications protocol. In some examples, an external device can wirelessly control the operation of the electronic lock 100, such as operation of the bolt 114. The electronic lock 100 can utilize wireless protocols including, but not limited to, the IEEE 802.11 standard (Wi-Fi®), the IEEE 802.15.4 standard (Zigbee® and Z-Wave®), the IEEE 802.15.1 standard (Bluetooth®), a cellular network, a wireless local area network, near-field communication protocol, Ultra WideBand (UWB) wireless communication protocol, and/or other networking and/or communication protocols. In some examples, the electronic lock 100 can wirelessly communicate with networked and/or distributed computing systems, such as may be present in a cloud-computing environment.

In a particular embodiment, the processor 136 will receive a signal at the Bluetooth interface 140 via a wireless communication protocol (e.g., BLE) from a mobile device 200 for communication of an intent to actuate the electronic lock 100. As illustrated in further detail below, the processor 136 can also initiate communication with the server 300 via Wi-Fi interface 139 (or another wireless interface) for purposes of validating an attempted actuation of the electronic lock 100, or receiving an actuation command to actuate the electronic lock 100. Additionally, various other settings can be viewed and/or modified via the Wi-Fi interface 139 from the server 300; as such, a user 12 of a mobile device 200 may access an account associated with the electronic lock 100 to view and modify settings of that lock, which are then propagated from the server 300 to the electronic lock 100. In alternative embodiments, other types of wireless interfaces can be used; generally, the wireless interface used for communication with a mobile device can operate using a different wireless protocol than a wireless interface used for communication with the server 300.

In a particular example, the Bluetooth interface 140 comprises a Bluetooth Low Energy (BLE) interface. Additionally, in some embodiments, the Bluetooth interface 140 is associated with a security chip 141, for example, a cryptographic circuit capable of storing cryptographic information and generating encryption keys usable to generate certificates for communication with other systems, e.g., mobile device 200.

The interior assembly 108 also includes the battery 142 to power the electronic lock 100. In one example, the battery 142 may be a standard single-use (disposable) battery. Alternatively, the battery 142 may be rechargeable. In still further embodiments, the battery 142 is optional altogether, replaced by an alternative power source (e.g., an AC power connection).

The interior assembly 108 also includes the motor 132 that is capable of actuating the bolt 114. In use, the motor 132 receives an actuation command from the processing unit 116, which causes the motor 132 to actuate the bolt 114 from the locked position to the unlocked position or from the unlocked position to the locked position. In some examples, the motor 132 actuates the bolt 114 to an opposing state. In some examples, the motor 132 receives a specified lock or unlock command, where the motor 132 only actuates the bolt 114 if the bolt 114 is in the correct position. For example, if the door 14 is locked and the motor 132 receives a lock command, then no action is taken. If the door 14 is locked and the motor 132 receives an unlock command, then the motor 132 actuates the bolt 114 to unlock the door 14.

As noted above, the optional interior antenna 134 may also be located in the interior assembly 108. In some examples, the interior antenna 134 is capable of operating together with the exterior antenna 130 to determine the location of the mobile device 200. In some examples, only a mobile device determined to be located on the exterior side 106 of the door 14 is able to unlock (or lock) the door 14. This prevents unauthorized users from being located near the electronic lock 100 and taking advantage of an authorized mobile device that may be located on the interior side 104 of the door 14, even though the authorized mobile device is not being used to unlock the door 14. In alternative embodiments, the interior antenna 134 can be excluded entirely, since the electronic lock 100 is actuated only by an authorized mobile device.

In alternative embodiments, one of the exterior antenna 130 and optional interior antenna 134 may be excluded, and an antenna array may be provided exclusively within the interior or exterior assembly. In such arrangements, wireless positioning technologies, such as Ultra-wideband wireless communication, may be used to detect a position of a device in communication with the electronic lock 100, e.g., by using an antenna array within one or the other of the interior or exterior assembly.

Referring to FIGS. 1-4 generally, in example embodiments, the electronic lock 100 may be used on both interior and exterior doors. Described herein are non-limiting examples of a wireless electronic lockset. It should be noted that the electronic lock 100 may be used on other types of doors, such as a garage door or a doggie door, or other types of doors that require an authentication process to unlock (or lock) the door.

In some embodiments, the electronic lock 100 is made of mixed metals and plastic, with engineered cavities to contain electronics and antennas. For example, in some embodiments, the lock utilizes an antenna near the exterior face of the lockset, designed inside the metal body of the lockset itself. The metal body can be engineered to meet strict physical security requirements and also allow an embedded front-facing antenna to propagate RF energy efficiently.

In still further example embodiments, the electronic lock 100 can include an integrated motion sensor 135. Using such a motion sensor (e.g., an accelerometer, gyroscope, or other position or motion sensor) and wireless capabilities of a mobile device or an electronic device (i.e., fob) with these capabilities embedded inside can assist in determining additional types of events (e.g., a door opening or door closing event, a lock actuation or lock position event, or a knock event based on vibration of the door). In some cases, motion events can cause the electronic lock 100 to perform certain processing, e.g., to communicatively connect to or transmit data to a mobile device 200 in proximity to the electronic lock 100.

Of course, in alternative embodiments, other lock actuation sequences may not require use of a motion sensor 135. For example, if the mobile device 200 is in valid range of the electronic lock 100 when using a particular wireless protocol (e.g., Bluetooth Low Energy), then a connection will be established with the electronic lock 100. Other arrangements are possible as well, using other connection sequences and/or communication protocols.

FIG. 5 illustrates an environment 10 in which a user 12 may control the electronic lock 100 or may customize settings for the electronic lock 100 through a mobile device or other computing device 200 with wireless communication capabilities. The mobile device 200 is capable of communicating 22 with a server 300 and communicating 20 with the electronic lock 100. The server 300 may be, for example, a physical server or a virtual server hosted in a cloud storage environment 16. In some embodiments, the electronic lock 100 is also capable of communicating 24 with the server 300. Such communication can optionally occur via one or more wireless communication protocols, e.g., Wi-Fi® (IEEE 802.11), short-range wireless communication to a Wi-Fi® bridge, or other connection mechanism. The server 300 may authenticate the electronic lock 100 before establishing a secure connection. Alternatively, the electronic lock 100 can authenticate the server 300 to establish a secure connection. In some instances, the server 300 and the electronic lock 100 operate to mutually authenticate each other in order to provide a higher level of security when establishing a connection. In still further embodiments, the server 300 may be excluded entirely, and configuration of the electronic lock 100 may be performed via direct communication connection between the mobile device 200 and the electronic lock 100.

The server 300 can be, for example, a physical server or a virtual server hosted in a cloud storage environment 16. In some embodiments, the electronic lock 100 is also capable of communicating 24 with the server 300. Such communication can optionally occur via one or more wireless communication protocols, e.g., Wi-Fi (IEEE 802.11), short-range wireless communication to a Wi-Fi bridge, or other connection mechanism. According to an embodiment, the server 300 generally creates and stores a user account associated with the electronic lock 100, stores a pairing passcode for the electronic lock 100, and stores settings for the electronic lock 100. In embodiments, the server 300 stores information associated with one or more presentation modes for the electronic lock 100.

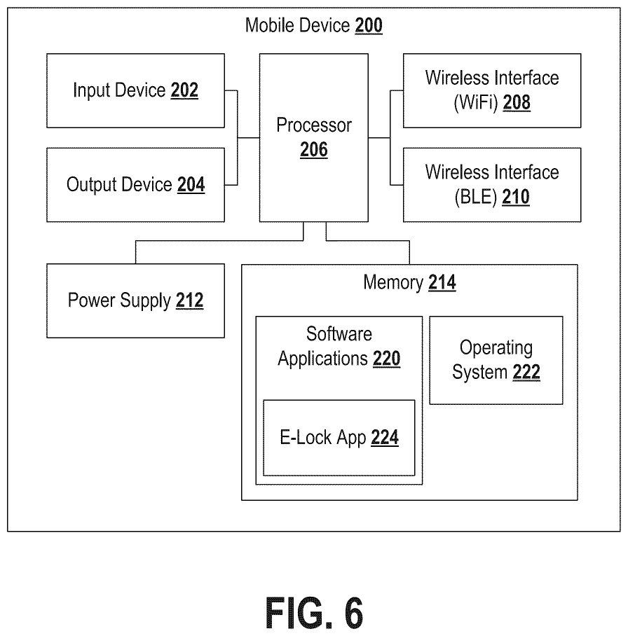

FIG. 6 illustrates a schematic diagram of a mobile device, such as mobile device 200, usable in embodiments of the disclosure to control the electronic lock 100 or customize settings for the electronic lock 100. In some embodiments, the mobile device 200 operates to form a Bluetooth or BLE connection with a network enabled security device such as the electronic lock 100. The mobile device 200 shown in FIG. 6 includes an input device 202, an output device 204, a processor 206, a wireless Wi-Fi interface 208, a wireless BLE interface 210, a power supply 212, and a memory 214.

The input device 202 operates to receive input from external sources. Such sources can include inputs received from a user (e.g., the user 12). The inputs can be received through a touchscreen, a stylus, a keyboard, etc.

The output device 204 operates to provide output of information from the mobile device 200. For example, a display can output visual information while a speaker can output audio information.

The processor 206 reads data and instructions. The data and instructions can be stored locally, received from an external source, or accessed from removable media.

The wireless Wi-Fi interface 208 is similar to the Wi-Fi interface 139. A Wi-Fi connection 22 can be established with the server 300.

The wireless BLE interface 210 is similar to the Bluetooth interface 140. A BLE connection 20 can be established with the electronic lock 100.

The power supply 212 provides power to the processor 206.

The memory 214 includes software applications 220 and an operating system 222. The memory 214 contains data and instructions that are usable by the processor to implement various functions of the mobile device 200.

The software applications 220 can include applications usable to perform various functions on the mobile device 200. One such application is an electronic lock application 224. In a particular embodiment, when the electronic lock application 224 is operating on the mobile device 200, the electronic lock application 224 can be configured to provide a user interface, setup/activate the electronic lock 100, generate a user account that is associated with the electronic lock 100, actuate the electronic lock 100, and customize settings of the electronic lock 100.

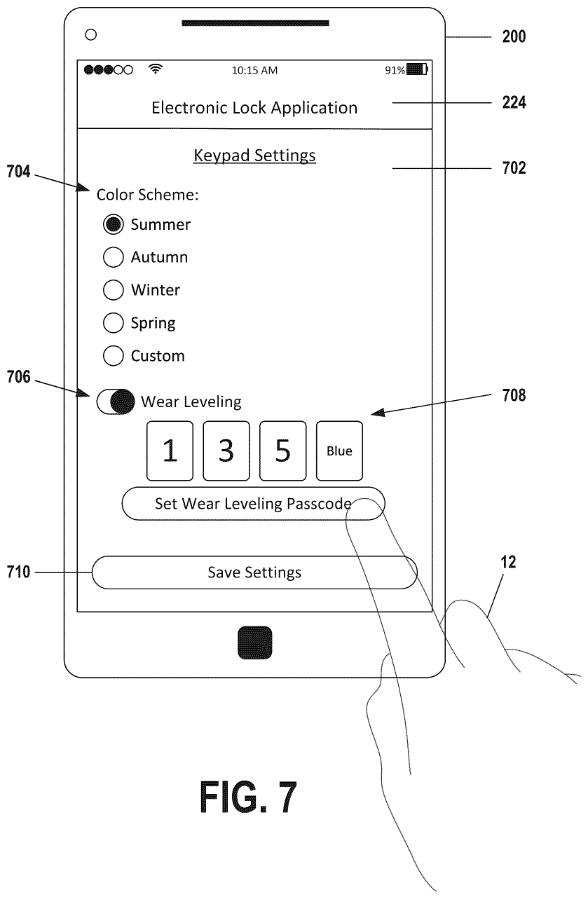

Referring now to FIGS. 7-22, details regarding a keypad for an electronic lock, and methods of configuring and using such a keypad, are described. In some examples, the electronic lock 100 and overall environment described above utilizing a mobile device 200 and optionally a server 300 are described in the context of configuration of the electronic lock 100, and in particular configuring operation and use of the keypad 120 that may be configured for multi-color display.

FIG. 7 illustrates a pictorial representation of aspects of customizing settings for the electronic lock 100. In the illustrated embodiment, the electronic lock 100 settings are customized through an electronic lock application 224 on a mobile device 200. In alternative embodiments, the settings of the electronic lock 100 may be customized in alternative manners. For example, other computing devices may be paired with the electronic lock 100 to customize electronic lock 100 settings. In another example, a user may interact with the keypad 120 of the electronic lock 100 to change electronic lock 100 settings.

In the illustrated embodiment, the mobile device 200 presents a user interface 702 of the electronic lock application 224 that includes various settings 704, 706 that allow the user 12 to change aspects of the electronic lock 100. In the illustrated embodiment, the settings 704, 706 control aspects of the keypad 120 of the electronic lock 100.

Theme settings 704 allow the user 12 to select from a plurality of predefined themes for the keypad 120. The themes may define colors displayed by the keypad 120 in presentation modes. For example, in the illustrated embodiment, the theme settings 704 include themes for different seasons. A “spring” theme may include spring-themed colors such as green, blue, and pink in an ornamental presentation mode of the keypad 120, whereas an “autumn” theme may include autumn-themed colors such as orange and red in an ornamental presentation mode of the keypad 120. Although these examples describe coloring in ornamental presentation modes, the theme may also define the coloring for other presentation modes, such as status message presentation modes and passcode entry presentation modes, as described herein.

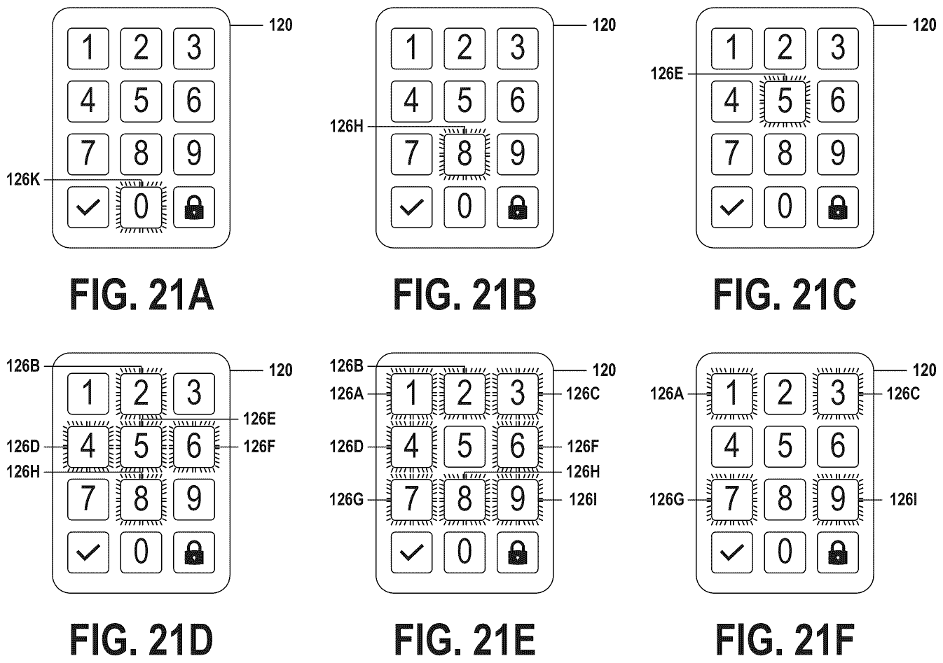

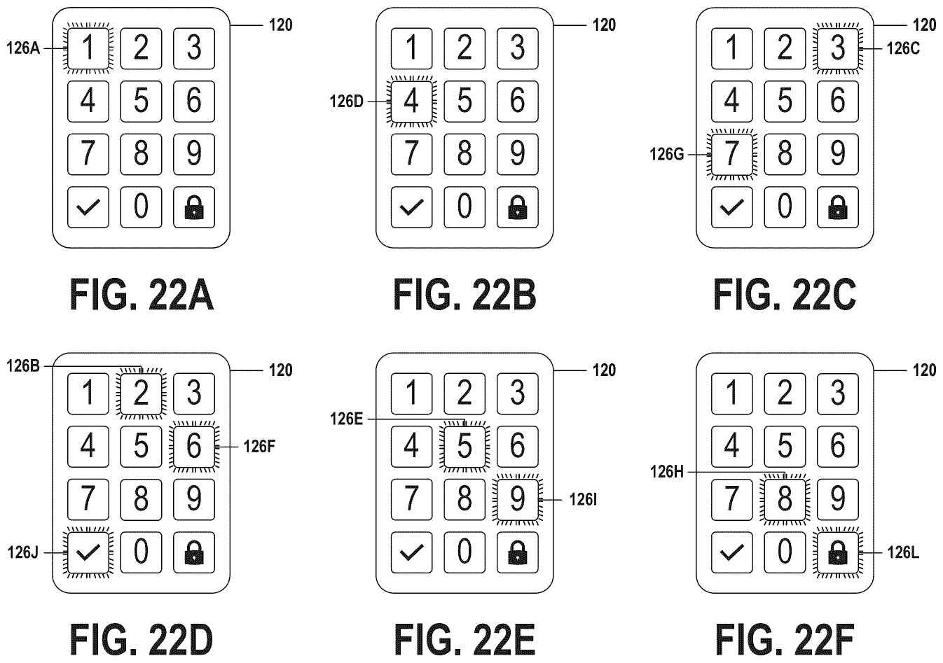

The presentation modes may additionally or alternatively define animations displayed by the keypad 120 in presentation modes. For example, in the illustrated embodiment, a “summer” theme may include an ornamental presentation mode that includes an animation of a firework (such as described with relation to FIGS. 21A-F), and a “winter” theme may include an ornamental presentation mode that includes an animation of snow falling (such as described with relation to FIGS. 22A-F). While these examples describe animations in ornamental presentation modes, the theme may also define animations for status message presentation modes, as described herein.

Although the theme settings 704 include predefined themes for different seasons, alternative embodiments may include predefined themes for any theme for which a color scheme or animation may be defined. For example, the theme settings 704 may include a predefined theme related to a vendor of the electronic lock 100, a country in which the electronic lock 100 is installed, or a regional sports team.

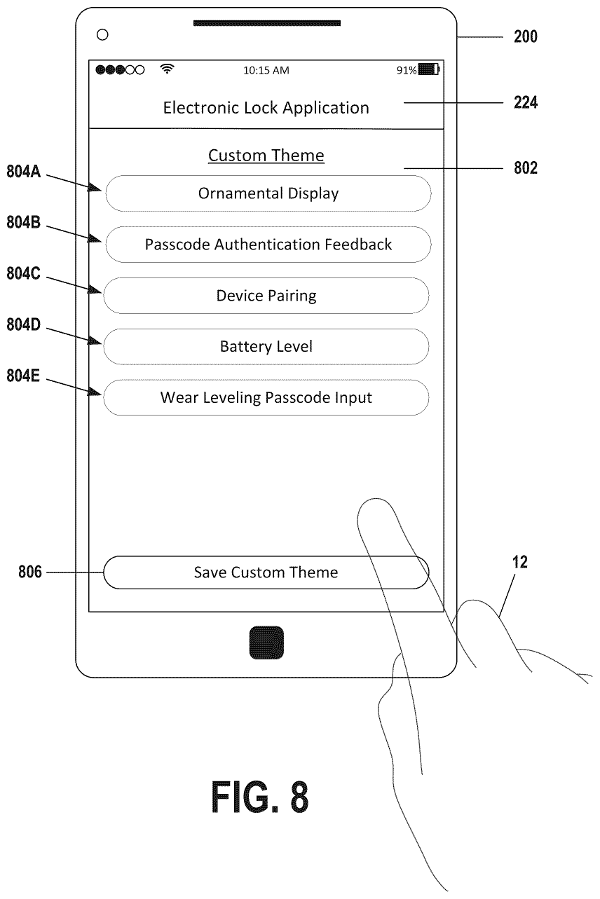

The theme settings 704 may also present a selectable option for the user 12 to define a custom theme. FIGS. 8-10 illustrates an example of user interfaces 802, 902, 1002 through which the user 12 may define a custom theme.

The user interface 702 in the illustrated embodiment also includes settings 706 to control a wear leveling passcode input presentation mode. Through the wear leveling settings 706, the electronic lock application 224 may receive, via user interface 702, a passcode 708 from a user 12 that includes both numbers and colors. Once set and synchronized to the electronic lock 100, the passcode 708 can then be received at the keypad 120 of the electronic lock 100 to lock/unlock the electronic lock 100, e.g., while the keypad 120 is in the wear leveling passcode input presentation mode.

After adjusting the settings 704, 706, the user 12 can select a save option 710 presented on the user interface 702 to save the settings 704, 706. After the settings 704, 706 are saved, the mobile device 200 may communicate the updated settings 704, 706 to the electronic lock 100 and/or the server 300.

Turning to FIGS. 8-10, pictorial representations of user interfaces 802, 902, 1002 for defining a custom theme for the keypad 120 are shown. FIG. 8 shows a user interface 802 depicting selectable options with which user 12 can choose between a plurality of presentation modes to customize for the custom theme. A plurality of options 804 are depicted within the user interface 802, and are associated with the plurality of presentation modes. The user 12 can select an option 804 (e.g., any of selectable options 804A-E) to customize the associated presentation mode. A save option 806 is also presented within the user interface 802; in response to selection by user 12, the selected customized presentation modes are saved for the custom theme.

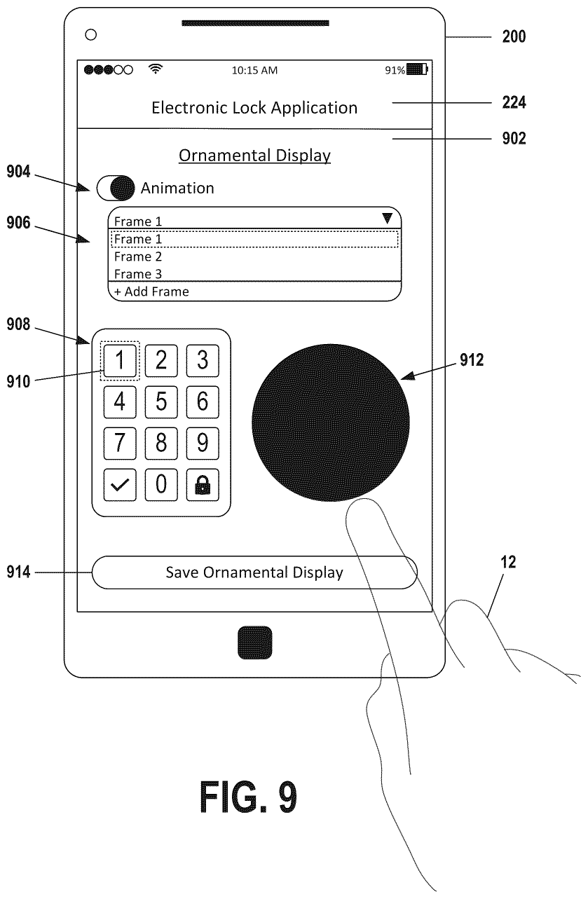

FIG. 9 illustrates an example user interface 902 for customizing a presentation mode. In the illustrated embodiment, the user interface 902 includes settings for customizing an ornamental presentation mode. In alternative embodiments, similar user interfaces may be used to customize other presentation modes, including status message presentation modes.

In the illustrated embodiment, the user interface 902 includes an option 904 to set an animation for the ornamental presentation mode. If the option 904 is selected, an animation may be set for the ornamental presentation mode. A menu 906 presents options for the user 12 to select from frames of the animation to edit, and the user 12 can add additional frames through the menu 906. If the option 904 is not selected, a static display may be set for the ornamental presentation mode.

A visual representation 908 of the keypad 120 and a color selector 912 are used to set colors for keypad regions 910 in the ornamental presentation mode, either for a frame of the animation or for the static display depending on selection of the option 904. The user 12 can select a keypad region 910 and use the color selector 912 to set a color for the selected keypad region 910. In the illustrated embodiment, the color selector 912 is a color wheel displaying a gradient of colors within a visible light spectrum. In alternative embodiments, the color selector 912 may be any element for selecting a color, including input boxes for setting color values, such as hex codes, RGB codes, or HSV codes.

After the ornamental presentation mode is set, the user can select a save option 914 that is presented in the user interface 902 to save the ornamental presentation mode for the custom theme.

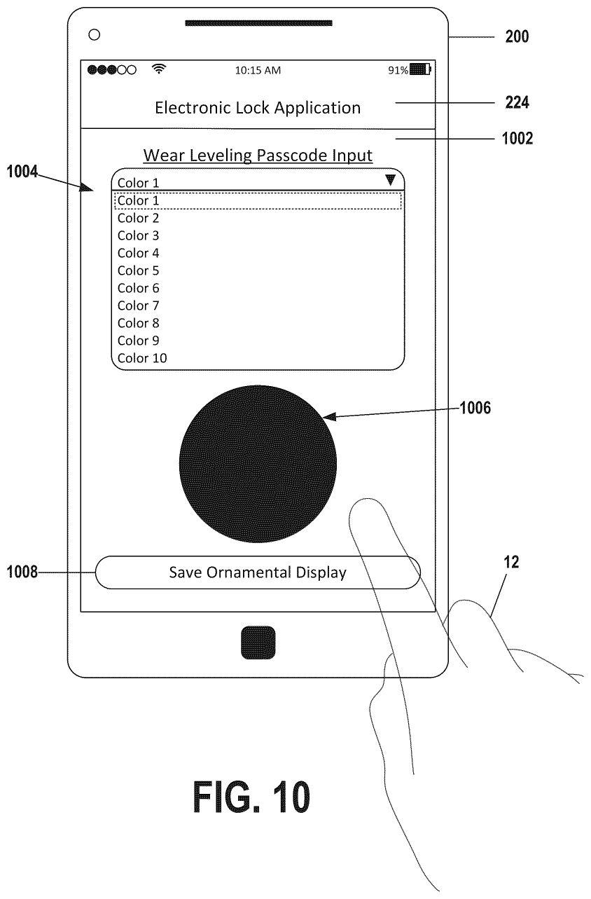

FIG. 10 illustrates a further example user interface 1002 for customizing a presentation mode. In the illustrated embodiment, the user interface 1002 includes settings for customizing a wear leveling passcode input presentation mode.

Through the user interface 1002, the user 12 can select a plurality of colors to be associated with keypad regions 126 of the keypad 120 when the keypad 120 is in the wear leveling passcode input presentation mode. In the illustrated embodiment, the user 12 can select ten colors, which may be associated with ten keypad regions 126 representing the numbers 0 through 9 when the keypad 120 is in the wear leveling passcode input presentation mode. In alternative embodiments, different numbers of colors may be selected which match a number of keypad regions 126. In an example, five colors can be selected to be associated with five or more keypad regions 126. In further embodiments, different numbers of colors may be selected which do not match a number of keypad regions 126. In an example, five colors can be selected to be associated with ten keypad regions 126. In such an example, each of the five colors may be associated with two keypad regions 126 such that each of the ten keypad regions 126 is associated with a color, or each of the five colors may be associated with one keypad region 126 such that five keypad regions 126 are associated with a color and five keypad regions 126 are not associated with a color. Other combinations of colors and keypad regions may be used as well.

The user interface 1002 includes a color selector 1006 to select the plurality of colors. As described above, the color selector 1006 may be a color wheel or any other color selection element. The user 12 can use a menu 1004 to determine which of the plurality of colors is being set by the color selector 1006. After setting values for the plurality of colors, a save option 1008 may be selected to save the wear leveling passcode input presentation mode for the custom theme.

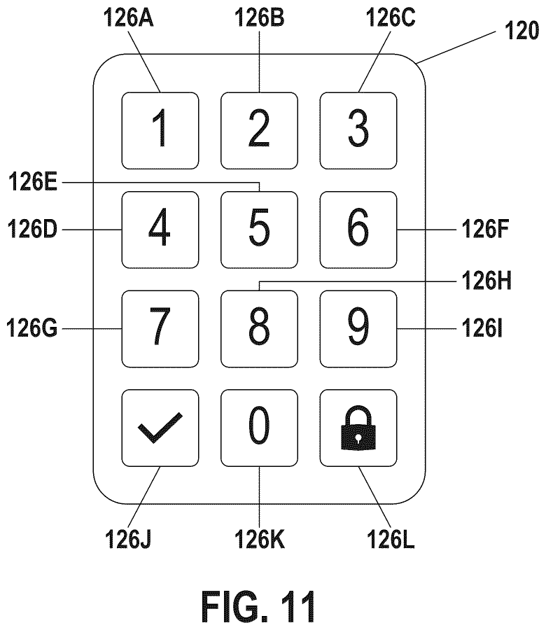

Turning to FIG. 11, an embodiment of a keypad 120 is shown. The keypad 120 includes a plurality of predefined keypad regions 126. In the illustrated embodiment, keypad regions 126A-I, 126K are associated with numbers. By associating the keypad regions 126A-I, 126K with numbers, the keypad 120 can be used to receive input of a passcode for locking/unlocking a door through interaction with the keypad regions 126A-I, 126K.

The keypad 120 may also include keypad regions 126J, 126L that are not associated with numbers. In the illustrated example, the keypad region 126J is an input sequence control. Selection of the keypad region 126J may signify the end of a sequence of keypad regions 126 selected by a user. In an example, when entering a passcode on the keypad 120—by selecting keypad regions 126A-I, 126K associated with numbers—selection of the keypad region 126J indicates that the user finished entering the passcode, and the passcode entered by the user is validated to lock/unlock the electronic lock 100. In another example, the user may enter a code to receive status information about the electronic lock 100, and selection of the keypad region 126J may indicate that the user finished entering the status information request code.

Additionally, in the illustrated embodiment, the keypad region 126L is a one-touch actuator. In this embodiment, selection of the keypad region 126L may initiate actuation of the electronic lock 100 if conditions are met. For example, if a paired mobile device 200 is detected by the electronic lock 100, selection of the keypad region 126L may initiate actuation of the electronic lock 100 from a locked position to an unlocked position. Alternatively, if a deadbolt of the electronic lock 100 is in the unlocked position, selection of the keypad region 126L may cause movement of the deadbolt to the locked position, irrespective of whether a paired mobile device 200 is sensed.

As previously described, the keypad regions 126 may include a plurality of buttons that can be mechanically actuated by the user (e.g., physically pressed), or the keypad regions 126 may be defined in a touch surface configured to detect a user's selection of a keypad region 126 by contact with the touch surface.

In embodiments, each keypad region 126 includes one or more lighting elements 156 (shown in FIG. 12) configured to illuminate the keypad regions 126 according to a presentation mode of the keypad 120. As described further herein, the presentation modes may be used to provide information about a status of the electronic lock 100, prompt entry of a passcode, or may be ornamental.

FIG. 12 illustrates an example of a circuit 150 in the keypad 120 including lighting elements 156. In the illustrated embodiment, the circuit 150 includes the lighting elements 156, a power supply 152, and a control input 154. The power supply 152 supplies power to the lighting elements 156. In some embodiments, the power supply 152 may output a pulse width modulated signal to the lighting elements 156. The pulse width modulated signal may control the brightness of the lighting elements 156. In an embodiment, the power supply 152 is the battery 142 in the interior assembly 108 of the electronic lock 100—as shown in FIG. 4. In alternative embodiments, the power supply 152 may be any electrical component capable of providing a voltage to the lighting elements 156.

The control input 154 controls illumination of the lighting elements 156. The control input 154 sends signals to the lighting elements 156, which when received by the lighting elements 156 cause the lighting elements 156 to illuminate in accordance with a presentation mode. In an embodiment, the control input 154 is the processor 136 in the processing unit 116 shown in FIG. 4. As previously described, the control input 154 may select a presentation mode for the keypad 120 based on received inputs at the keypad 120. For example, upon receipt of a status message request code at the keypad 120, the control input 154 may select a status message presentation mode and send signals to the lighting elements 156 in accordance with the status message presentation mode. In another example, the control input 154 may select a presentation mode based on conditions sensed by sensors and/or wireless interfaces of the electronic lock 100. For example, upon detection of a user proximate to the electronic lock 100, the control input 154 may select an ornamental presentation mode and send signals to the lighting elements 156 based on the selected ornamental presentation mode.

In the illustrated embodiment, the lighting elements 156 are connected in a chain, e.g., in series. In this embodiment, the control input 154 sends a signal to a first lighting element 156A. The first lighting element 156A then passes the signal down the chain to a second lighting element 156B. The lighting elements 156 continue to pass the signal down the chain until the signal reaches a last lighting element 156Z. The control signals may identify a particular one of the lighting elements 156 intended to illuminate, as well as a particular illumination hue and illumination level. Accordingly, each lighting element 156 sequentially receives the signal from the control input 154 in accordance with a system-wide data communication frequency defined by the control input 154. In the illustrated embodiment, the lighting elements 156 include four pins: a first pin to receive a control signal, a second pin to receive input power, a third pin to output a control signal, and a fourth pin connected to electrical ground.

In examples, each lighting element 156 may include a plurality of light emitting elements, such as light-emitting diodes, of different colors. In some examples, each lighting element 156 may include a red, green, and blue light emitting diode, each of which may be selectively actuated at different intensities to generate a broad spectrum of colors from the lighting element. In further embodiments, each lighting element 156 may include white, red, green, and blue lighting elements. In an embodiment, the lighting elements 156 are implemented using IN-PI15TAT5R5G5B light-emitting diode chips manufactured by Inolux corporation having its principal place of business in Santa Clara, CA. In alternative embodiments, the lighting elements 156 may be any electrical component capable of producing light, in particular multi-colored light.

As generally referenced above, although in the example shown three lighting elements 156 are illustrated for purposes of simplicity, other numbers of lighting elements 156 may be used. In particular embodiments, at least one lighting element 156 may be included within the circuit 150 and is placed such that it may be physically associated with each keypad region of a keypad, e.g., each keypad region 126 as illustrated in FIG. 12. For example, a lighting element 156 may be placed in proximity to or below a translucent or semi-translucent membrane of a depressible keypad region. Other keypad constructions may be used as well, including touch-sensor based keypads that use, e.g., capacitive touch sensing rather than a depressible membrane to receive touch inputs.

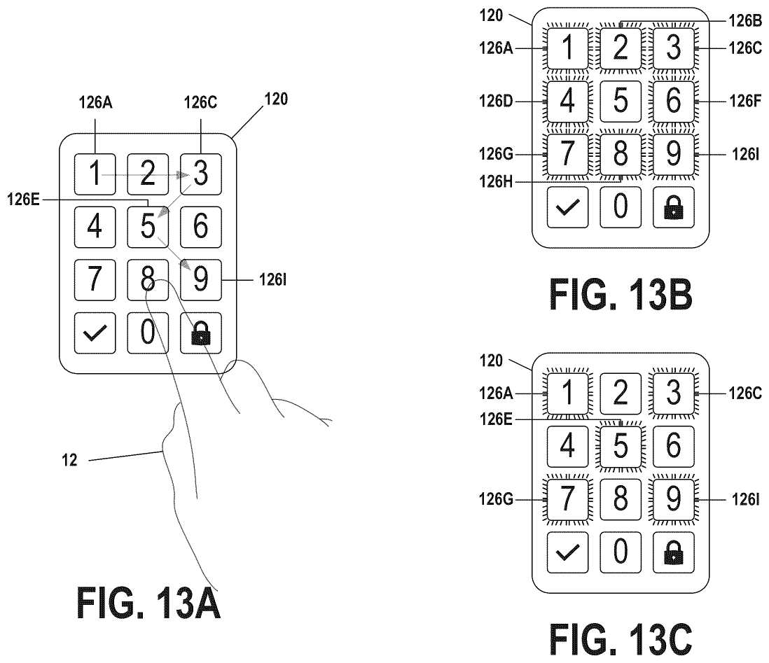

Turning now to FIGS. 13A-C, a first example of a keypad 120 illuminating according to a presentation mode is shown. In the illustrated example, the presentation mode is a status message presentation mode in response to a user 12 entering an actuation passcode on the keypad 120. FIG. 13A shows the user 12 entering the actuation passcode on the keypad 120. In the illustrated example, the user 12 enters a four-digit passcode by interacting with keypad regions 126A, 126C, 126E, 126I. In an embodiment, the processor 136 (shown in FIG. 4) determines if the passcode entered by the user 12 is correct or incorrect and selects a status message presentation mode in which the keypad 120 is illuminated. Lighting elements 156 (shown in FIG. 12) receive a signal from the processor 136 and illuminate keypad regions 126 on the keypad 120 in accordance with the selected presentation mode to inform the user 12 about a status of the electronic lock 100. In alternative embodiments, other components of the electrical lock 100 may determine if the passcode entered by the user 12 is valid and/or select the presentation mode.

FIG. 13B illustrates an example of the keypad 120 illuminating to indicate that the passcode entered by the user 12 is valid. In the illustrated embodiment, lighting elements associated with the keypad regions 126A-D, 126F-I illuminate, indicating to the user 12 that the passcode is valid. In an example embodiment, the lighting elements illuminate the keypad regions 126A-D, 126F-I in a green light. In alternative embodiments, the keypad regions 126A-D, 126F-I are illuminated in different colored light. Additionally, while the illustrated embodiment shows a static display of the keypad regions 126A-D, 126F-I illuminated, in alternative embodiments, the keypad regions 126A-D, 126F-I may illuminate in a pattern to display an animation on the keypad 120. For example, the keypad regions 126A-D, 126F-I may pulse as an animation. As previously discussed, the colors and animations displayed on the keypad 120 may be customized by the user 12.

In an embodiment, in addition to determining if the passcode was valid, the processor 136 may determine if the electronic lock 100 properly locked/unlocked. For example, the processor 136 may determine if a doorjamb prevented the bolt 114 from fully extending to properly lock the door 14. In such examples, a presentation mode may be selected that indicates that the passcode entered by the user 12 is valid but there was an error actuating the electronic lock 100. In an example, the keypad regions 126A-D, 126F-I may illuminate green if the passcode is valid and the electronic lock 100 properly actuated, and the keypad regions 126A-D, 126F-I may illuminate blue if the passcode is valid but the electronic lock 100 did not properly actuate. As with other examples, the keypad regions 126A-D, 126F-I may illuminate in different colors than described in the examples and/or may illuminate in a pattern to display an animation on the keypad 120.

FIG. 13C illustrates an example of the keypad 120 illuminating to indicate that the passcode entered by the user 12 is invalid. In the illustrated example, lighting elements associated with the keypad regions 126A, 126C, 126E, 126G, 126I illuminate, indicating to the user 12 that the passcode is invalid. In an example embodiment, the keypad regions 126A, 126C, 126E, 126G, 126I are illuminated in a red light. In alternative embodiments, the keypad regions 126A, 126C, 126E, 126G, 126I may illuminate in different colors than described in the examples and/or may illuminate in a pattern to display an animation on the keypad 120.

In embodiments, each of the displays described with relation to FIGS. 13B-C may be associated with a single passcode validation presentation mode, and the display of the keypad 120 in the passcode validation presentation mode varies based on whether the entered passcode is valid—and in some embodiments, the display also depends on whether an error occurred in actuating the electronic lock 100, as described above. In alternative embodiments, each of the displays described above is associated with its own presentation mode, and which presentation mode is selected is determined by if the passcode is valid (and if the electronic lock 100 actuated successfully). For example, the display shown in FIG. 13B may be associated with a valid passcode presentation mode, and the display shown in FIG. 13C may be associated with an invalid passcode presentation mode.

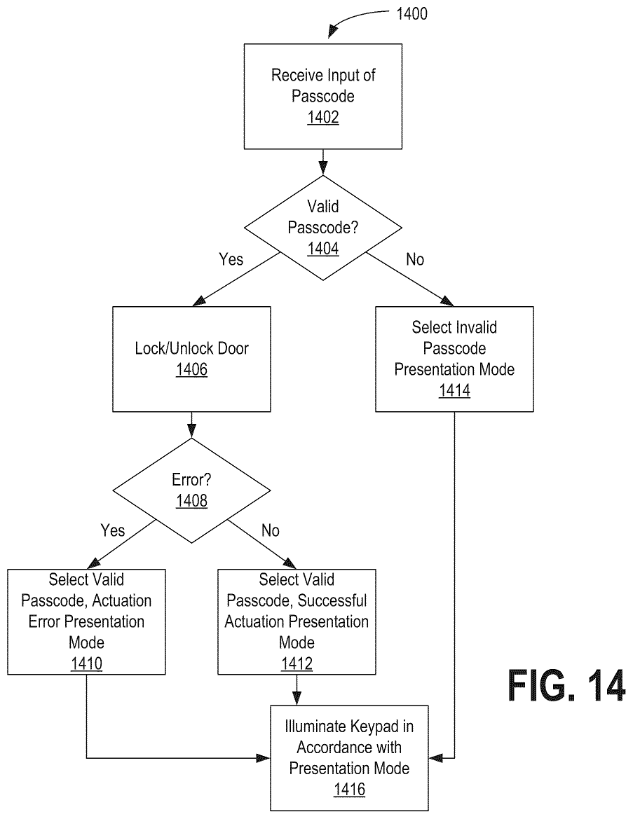

FIG. 14 illustrates a flowchart of an example method 1400 for providing lock status information via illumination of a keypad of an electronic lock. The method 1400 includes operations 1402, 1404, 1406, 1408, 1410, 1412, 1414, 1416, and may be performed by a controller of an electronic lock 100, in example implementations.

In the example shown, operation 1402 includes receiving input of a passcode at a keypad. The operation 1402 may be performed by a keypad with predefined keypad regions. In an embodiment, the keypad regions are associated with numbers and/or colors. A user selects the keypad regions in a sequence to input the passcode at the keypad.

Operation 1404 includes determining if the passcode input during the operation 1402 is valid. The passcode input during the operation 1402 may be validated by comparing the input passcode to a stored valid passcode. In an embodiment, the operation 1404 is performed by a processor in the electronic lock. The processor may compare the input passcode to a valid passcode stored in a memory of the electronic lock. If the passcode is valid, the method 1400 proceeds to the operation 1406. If the passcode is invalid, the method 1400 proceeds to the operation 1414.

Operation 1406 includes actuating the electronic lock to lock or unlock a door. In an embodiment, a motor is activated to move a bolt between a locked and unlocked position.

Operation 1408 includes determining if an error occurred during the operation 1406 to lock/unlock the door. For example, the operation 1408 may be performed to determine if the bolt properly transitioned between the locked and unlocked positions during the operation 1406. In an embodiment, the processor determines if an error occurred while locking/unlocking the door. If an error is detected, the method 1400 proceeds to the operation 1410. If an error is not detected, the method 1400 proceeds to the operation 1412.

Operation 1410 includes selecting a valid passcode, actuation error presentation mode. The presentation mode may be selected from among a plurality of stored presentation modes. In an embodiment, the presentation mode is selected by the processor. The selected presentation mode may be stored along with a plurality of presentation modes in the memory of the electronic lock.

Operation 1412 includes selecting a valid passcode, successful actuation presentation mode. The operation 1412 may be similar to the operation 1410 previously described.

If the passcode entered during operation 1402 is determined to be invalid during operation 1404, operation 1414 is performed to select an invalid passcode presentation mode. Operation 1414 may be similar to operation 1410 previously described.

After a presentation mode is selected, operation 1416 is performed. Operation 1416 includes illuminating the keypad in accordance with the selected presentation mode. In embodiments, the colors displayed on the keypad are determined by the presentation mode. In additional embodiments, an animation is displayed on the keypad based on the presentation mode. For example, if the presentation mode is a valid passcode, successful actuation presentation mode, the keypad may illuminate to display a green circle-similar to the embodiment shown in FIG. 13B. In another example, if the presentation mode is a valid passcode, successful actuation presentation mode, the keypad may illuminate to display a pulsing blue circle-similar to the embodiment shown in FIG. 13B. In another example, if the presentation mode is an invalid passcode presentation mode, the keypad may illuminate to display a red “X”—similar to the embodiment shown in FIG. 13C. In an embodiment, the processor sends signals to lighting elements in the keypad regions, causing the lighting elements to illuminate the keypad regions in accordance with the presentation mode.

In alternative embodiments, operations 1410, 1412, 1414 may be condensed to a single operation in which the same passcode validation presentation mode is selected regardless of whether the passcode entered during operation 1402 is valid or whether an error occurred when locking/unlocking the door during operation 1406. During operation 1416, the keypad may illuminate differently while in the passcode validation presentation mode based on the input passcode and/or locking/unlocking errors. For example, in embodiments, the processor sends signals to lighting elements in the keypad regions, causing the lighting elements to illuminate the keypad regions in accordance with the passcode validation presentation mode. In such examples, the processor may send different signals based on the input passcode and/or locking/unlocking errors even though the selected passcode validation presentation mode is the same.

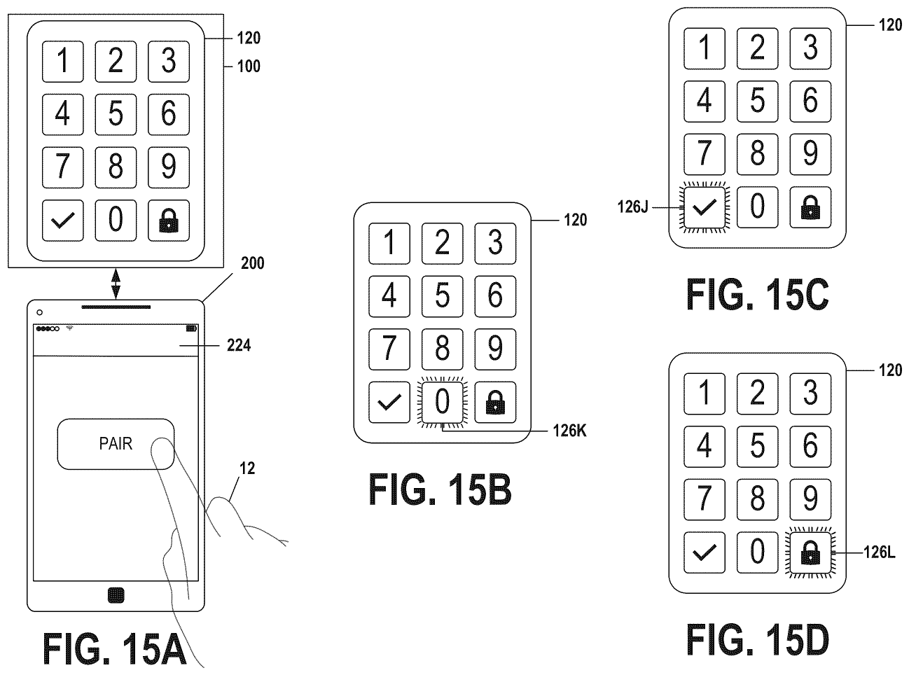

FIGS. 15A-D illustrate a second example of a keypad 120 illuminating in accordance with a presentation mode. In the illustrated embodiment, the presentation mode is a status message presentation mode in response to a mobile device 200 pairing with an electronic lock 100. FIG. 15A shows a user 12 initiating a pairing of the mobile device 200 and the electronic lock 100. In the illustrated embodiment, the mobile device is executing an electronic lock application 224. The mobile device 200 and the electronic lock 100 may pair over a BLE connection or other wireless communication protocol.

FIG. 15B illustrates an example of the keypad 120 illuminating while the mobile device 200 and the electronic lock 100 are pairing. In the illustrated embodiment, a pairing in progress presentation mode is selected, and the keypad 120 illuminates to inform the user 12 that the electronic lock 100 is attempting to pair with the mobile device 200. Lighting elements in a keypad region 126K illuminate the keypad region 126K in accordance with the presentation mode. In an example, the keypad region 126K illuminates with a pulsing blue light.

After a pairing process is complete, another presentation mode may be selected, and the keypad 120 may be illuminated to indicate completion of the pairing process. If the pairing process is successful, a successful pairing presentation mode may be selected, whereas if the pairing process is unsuccessful, an unsuccessful pairing presentation mode may be selected. In alternative embodiments, the pairing in progress presentation mode may continue after the pairing is complete, and different signals are sent to the lighting elements based on whether the pairing was successful or unsuccessful.

FIG. 15C illustrates an example of the keypad 120 illuminating to indicate successful pairing of the mobile device 200 and the electronic lock 100. In the illustrated embodiment, lighting elements in a keypad region 126J illuminate the keypad region 126J in accordance with the successful pairing presentation mode. In an example, the keypad region 126J illuminates with a green light.

FIG. 15D illustrates an example of the keypad illuminating to indicate unsuccessful pairing of the mobile device 200 and the electronic lock 100. In the illustrated embodiment, lighting elements in a keypad region 126L illuminate the keypad region 126L in accordance with the unsuccessful pairing presentation mode. In an example, the keypad region 126L illuminates with a red light.

As previously described, FIGS. 15B-D illustrate one example of the keypad 120 illuminating to indicate pairing of the mobile device 200 with the electronic lock 100. The keypad 120 may illuminate differently in different examples, with keypad regions 126 illuminating with different colors and/or to display an animation.

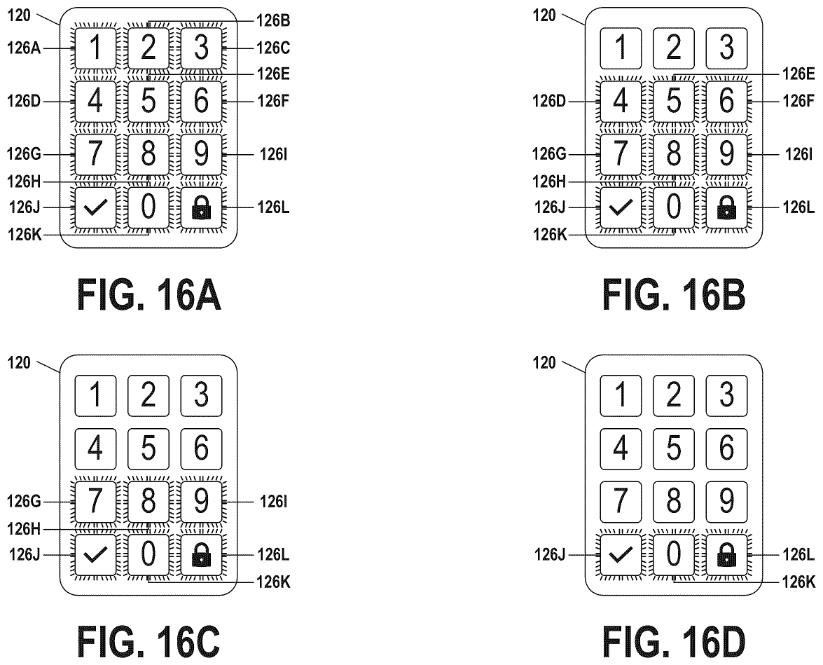

FIGS. 16A-D illustrate a third example of a keypad 120 illuminating in accordance with a presentation mode. In the illustrated embodiments, the presentation mode is a status message presentation mode to display a current battery level in an electronic lock 100 of which the keypad 120 is a part. In an embodiment, this presentation mode may be selected by a user by interacting with the keypad 120. For example, a user may input a code into the keypad 120 by interacting with keypad regions 126 to cause the keypad 120 to display the current battery level. In another embodiment, the user interacts with the keypad 120 via an electronic lock application on a mobile device to cause the keypad 120 to display the current battery level. In yet another embodiment, a processor 136 in the electronic lock 100 may select the battery level presentation mode in response to conditions detected by the electronic lock 100 or components of the electronic lock 100. For example, the processor 136 may determine that the battery level has crossed a threshold and select the battery level presentation mode the next time a sensor determines that a user is proximate to the keypad 120.

FIG. 16A illustrates an example of the keypad 120 illuminating to indicate a high battery level—for example, a battery level above 75%. In the illustrated embodiment, lighting elements in all of the keypad regions 126A-L illuminate the keypad regions 126A-L. In an example, the keypad regions 126A-L illuminate with green light.

FIG. 16B illustrates an example of the keypad 120 illuminating to indicate a moderately high battery level—for example, a battery level between 50% and 75%. In the illustrated embodiment, lighting elements in the keypad regions 126D-L illuminate the keypad regions 126D-L. In an example, the keypad regions 126D-L illuminate with green light.

FIG. 16C illustrates an example of the keypad 120 illuminating to indicate a moderately low battery level—for example, a battery level between 25% and 50%. In the illustrated embodiment, lighting elements in the keypad regions 126G-L illuminate the keypad regions 126G-L. In an example, the keypad regions 126G-L illuminate with yellow light.

FIG. 16D illustrates an example of the keypad illuminating to indicate a low battery level—for example, a battery level below 25%. In the illustrated embodiment, lighting elements in the keypad regions 126J-L illuminate the keypad regions 126J-L. In an example, the keypad regions 126J-L illuminate with red light. In an embodiment, if the battery level is critically low—for example, below 10%—the keypad regions 126J-L may illuminate with pulsing red light.

In other examples, the keypad 120 may display an animation to indicate the battery level of the electronic lock 100. In such embodiments, FIGS. 16A-D may illustrate, or represent, frames of the animation. For example, if the battery level is high (over 75%), the keypad 120 may first display the frame shown in FIG. 16D followed by the frames shown in FIG. 16C, FIG. 16B, and FIG. 16A, respectively, and may use a common color (e.g., green) during display of such frames. In another example, if the battery level is moderately high (between 50% and 75%), the keypad may display the frames shown in FIG. 16D, FIG. 16C, and FIG. 16B, respectively, and may use a common color (e.g., green) during display of such frames. If a moderately low battery level is to be indicated, the keypad may display the frames shown in FIGS. 16D and 16C, respectively, and may use a different common color (e.g., yellow) during display of such frames. Other combinations of displays to form animated sequences using different colors may be implemented as well, consistent with the present disclosure.

In some embodiments, each of the displays shown in FIGS. 16A-D is associated with a single battery level presentation mode, and the display of the keypad 120 in the battery level presentation mode varies based on the battery level of the electronic lock 100. In alternative embodiments, each of the displays shown in FIGS. 16A-D is associated with its own battery level presentation mode, and which battery level presentation mode is selected is determined by the battery level of the electronic lock 100—e.g., the display shown in FIG. 16A may be associated with a high battery level presentation mode, and the display shown in FIG. 16D may be associated with a low battery presentation mode.

As with previous examples, FIGS. 16A-D illustrate one example of the keypad 120 illuminating to indicate the battery level of the electronic lock 100. The keypad 120 may illuminate differently in different examples, with keypad regions 126 illuminating with different colors and/or to display an animation.

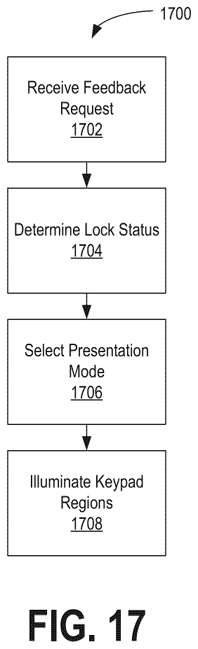

FIG. 17 illustrates a flowchart of an example method 1700 for illuminating a keypad based on a status message presentation mode. The method 1700 includes operation 1702, 1704, 1706, 1708, and may be performed by a controller of an electronic lock 100, in example implementations.

In the example shown, operation 1702 includes receiving a feedback request regarding a status of an electronic lock of which the keypad is a part. For example, a user may request feedback regarding a battery level of the electronic lock. In an embodiment, the feedback request is received by a processor in an electronic lock of which the keypad is a part. In an example, the processor receives the request from the keypad after the user inputs a code into the keypad. In another example, the processor receives the request from a BLE interface in communication with a mobile device executing an electronic lock application.

Operation 1704 includes determining the status of the electronic lock. The status that is determined is based on the feedback request received during the operation 1702. For example, if the feedback request is for a battery level of the electronic lock, the battery level of the electronic lock is determined during the operation 1704. In an embodiment, a processor determines the status of the electronic lock. For example, the processor may determine the battery level of the electronic lock by checking a charge on a battery in the electronic lock.

Operation 1706 includes selecting a presentation mode. The presentation mode is selected based on the feedback request received during the operation 1702. For example, if the feedback request is for a battery level of the electronic lock, the presentation mode selected is a battery level presentation mode. The presentation mode may also be selected based on the status of the electronic lock determined during the operation 1704. In the example of selecting a battery level presentation mode, the presentation mode may be selected based on the battery level of the electronic lock. For example, if the battery level is high, a high battery level presentation mode is selected. In an embodiment, a processor selects the presentation mode. The processor may select the presentation mode from a plurality of presentation modes stored in a memory of the electronic lock.

Operation 1708 includes illuminating one or more keypad regions. The keypad regions are illuminated in accordance with the presentation mode selected during the operation 1706. The selected presentation mode determines colors that the keypad regions are illuminated. The selected presentation mode may also determine a pattern in which the keypad regions are illuminated such that the keypad displays an animation. In an embodiment, lighting elements in the keypad regions receive signals from the processor and illuminate in accordance with the selected presentation mode.

In alternative embodiments, operations 1702, 1704, 1706, 1708 may be performed in a different order than shown in FIG. 17. For example, the presentation mode may be selected before the lock status is determined.

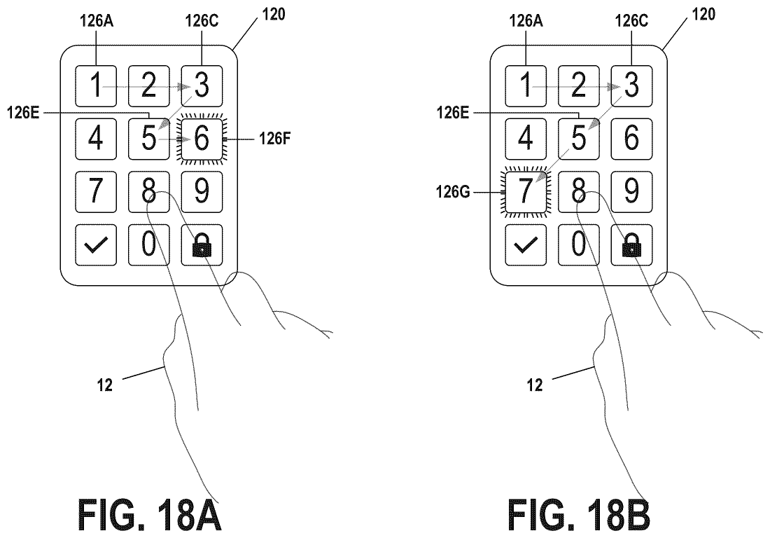

FIGS. 18A-B illustrate a further example of a keypad 120 illuminating in accordance with a presentation mode. In the illustrated embodiments, the presentation mode is a wear leveling passcode input presentation mode. In an embodiment, this presentation mode may be selected by a processor in response to detection of a user proximate to the keypad 120. In this presentation mode, at least one keypad region 126 is illuminated in a color, and selection of the keypad region 126 illuminated in the color is part of a passcode input process. In an embodiment, each of the keypad regions 126 associated with a number also are illuminated in a color from a predetermined set of colors. For example, ten colors may be included in the predetermined set of colors such that each keypad region 126 is associated with a number between 0 and 9 and is also associated with a unique color in the predetermined set of colors.

A user 12 may have an actuation passcode including both numbers and colors. For example, the actuation passcode may be “1-3-5-Blue.” To enter the actuation passcode into the keypad 120, the user 12 may select the keypad regions 126 associated with the numbers and colors in the actuation passcode. In the example illustrated in FIG. 18A, the keypad region 126F may be illuminated blue. Accordingly, the user 12 may enter the actuation passcode by selecting the keypad regions 126A, 126C, 126E, 126F in the correct sequence. Although not shown in FIG. 18A, the other keypad regions 126 may also be illuminated with a color.

To balance the wear of the keypad regions 126 more evenly, the association of colors with the keypad regions 126 may be randomized, and the location of a color in the actuation passcode may differ across multiple instances of the passcode input process. For example, as shown in FIG. 18B, the keypad region 126G may be illuminated blue, rather than the keypad region 126F like is shown in FIG. 18A. Like with FIG. 18A, the other keypad regions 126 may also be illuminated with a color, even though it is not shown in FIG. 18B. Accordingly, the user may enter the actuation passcode by selection the keypad regions 126A, 126C, 126E, 126G in the correct sequence. By more evenly balancing the wear on the keypad regions 126, it may be more difficult for unauthorized users to guess the actuation passcode based on the wear or signs of use (e.g., fingerprints, and the like) that may become visibly apparent on the keypad regions 126 over time.

In an embodiment, the electronic lock 100 has a single passcode input presentation mode, and the associations between colors and keypad regions 126 are randomized each time the passcode input presentation mode is selected. In alternative embodiments, the electronic lock 100 has a plurality of passcode input presentation modes, and each passcode input presentation mode defines a different association between colors and keypad regions 126. In an example of such embodiments, a random passcode input presentation mode may be selected in response to detection of a user proximate to the keypad 120.

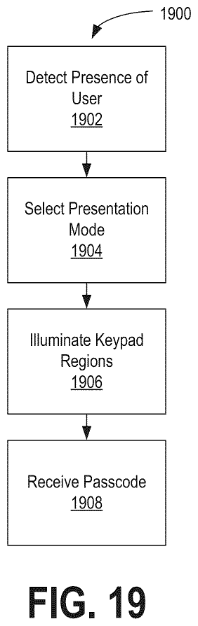

FIG. 19 illustrates a flowchart of an example method 1900 for illuminating a keypad for a passcode input process for an electronic lock. The method 1900 includes operations 1902, 1904, 1906, 1908 and may be performed by a controller of an electronic lock 100, in example implementations.

In the example shown, operation 1902 includes detecting the presence of a user proximate to the keypad. In an embodiment, a sensor in the electronic lock is used to detect the presence of the user. For example, a proximity sensor may be used to detect user presence. In another embodiment, one or more antennae in the electronic lock are used to detect the presence of the user. For example, an interior antenna and an exterior antenna may be used to determine the location of a paired mobile device.

Operation 1904 includes selecting a presentation mode. The presentation mode may be selected from among a plurality of presentation modes. In an embodiment, the presentation mode selected is a passcode input presentation mode. In an embodiment, the presentation mode is selected by a processor in the electronic lock. The processor may select the presentation mode from among a plurality of presentation modes stored in a memory of the electronic lock.

Operation 1906 includes illuminating keypad regions. The keypad regions are illuminated in accordance with the presentation mode selected during the operation 1904. The selected presentation mode determines colors that the keypad regions are illuminated. In the illustrated embodiment, because the presentation mode is a passcode input presentation mode, each keypad region may be illuminated in a different color. As previously described, the associations between keypad regions and colors may be randomized to more evenly balance wear on the keypad regions. In an embodiment, a processor sends signals to lighting elements in the keypad regions, and the lighting elements illuminate the keypad regions in accordance with the selected presentation mode.

Operation 1908 includes receiving a passcode. In embodiments, the passcode is a combination of numbers and colors. In an embodiment, the passcode is received by the keypad via user interaction with the keypad regions illuminated during the operation 1906.

In alternative embodiments, the method 1900 may include additional operation similar to operations 1404, 1406, 1408, 1410, 1412, 1414, 1416 of the method 1400 shown in FIG. 14 to validate the passcode and illuminate the keypad based on status message presentation modes.

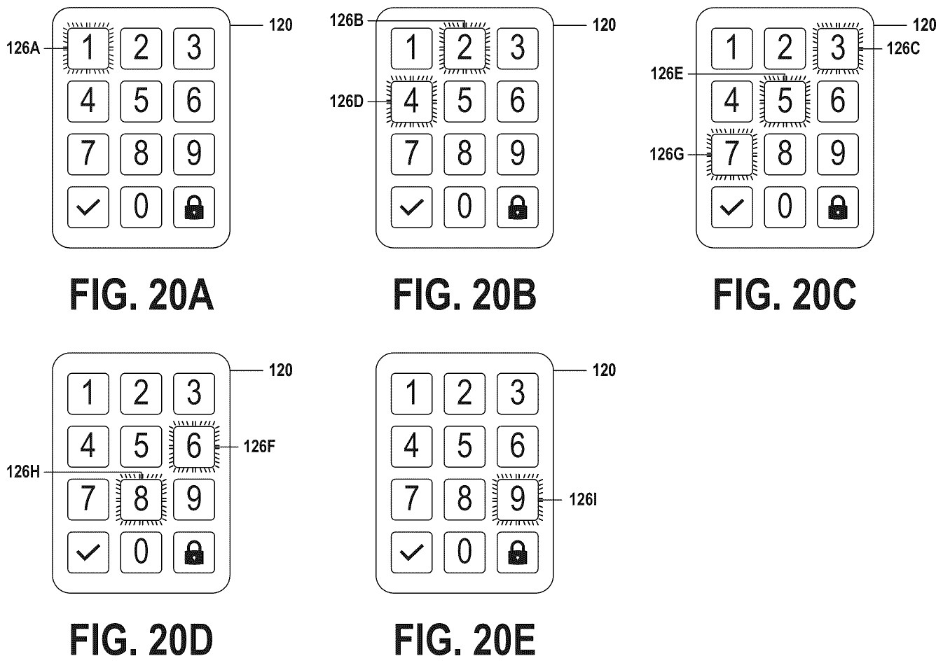

Turning to FIGS. 20A-E, a still further example of a keypad 120 illuminating in accordance with a presentation mode is shown. In the illustrated embodiments, the presentation mode is an ornamental presentation mode. In embodiments, the ornamental presentation mode is selected by a processor detecting a user proximate to the keypad 120. Each of the FIGS. 20A-E illustrate a frame of an animation displayed on the keypad 120 through illumination of keypad regions 126 in the ornamental presentation mode, and each frame is shown sequentially to create the animation. In the illustrated example, the animation shows a wave moving across the keypad.

In a first frame, shown in FIG. 20A, the keypad region 126A is illuminated. In a second frame, shown in FIG. 20B, the keypad regions 126B, 126D are illuminated. In a third frame, shown in FIG. 20C, the keypad regions 126C, 126E, 126G are illuminated. In a fourth frame shown in FIG. 20D, the keypad regions 126F, 126H are illuminated. In a fifth frame, shown in FIG. 20E, the keypad region 126I is illuminated. In an example, the keypad regions 126 are illuminated in the same color across the five frames.

FIGS. 21A-F illustrate a further example of a keypad 120 illuminating in accordance with a presentation mode. Like in the previous example, the presentation mode is an ornamental presentation mode and is selected by a processor detecting a user proximate to the keypad 120. Each of the FIGS. 21A-F illustrate a frame of an animation displayed on the keypad 120 through illumination of keypad regions 126 in the ornamental presentation mode, and each frame is shown sequentially to create the animation. In the illustrated example, the animation shows a firework shooting off.

In a first frame, shown in FIG. 21A, the keypad region 126K is illuminated. In a second frame, shown in FIG. 21B, the keypad region 126H is illuminated. In a third frame, shown in FIG. 21C, the keypad region 126E is illuminated. In a fourth frame shown in FIG. 21D, the keypad regions 126B, 126D-F, 126H are illuminated. In a fifth frame, shown in FIG. 21E, the keypad regions 126A-D, 126F-I are illuminated. In a sixth frame, shown in FIG. 21F, the keypad regions 126A, 126C, 126G, 126I are illuminated. In an example, the keypad regions 126 are illuminated in the same color across the six frames.

FIGS. 22A-F illustrate a further example of a keypad 120 illuminating in accordance with a presentation mode. Like in the previous example, the presentation mode is an ornamental presentation mode and is selected by a processor detecting a user proximate to the keypad 120. Each of the FIGS. 22A-F illustrate a frame of an animation displayed on the keypad 120 through illumination of keypad regions 126 in the ornamental presentation mode, and each frame is shown sequentially to create the animation. In the illustrated example, the animation shows snow falling.

In a first frame, shown in FIG. 22A, the keypad region 126A is illuminated. In a second frame, shown in FIG. 22B, the keypad region 126D is illuminated. In a third frame, shown in FIG. 22C, the keypad regions 126C, 126G are illuminated. In a fourth frame shown in FIG. 22D, the keypad regions 126B, 126F, 126J are illuminated. In a fifth frame, shown in FIG. 22E, the keypad regions 126E, 126I are illuminated. In a sixth frame, shown in FIG. 22F, the keypad regions 126H, 126L are illuminated. In an example, the keypad regions 126 are illuminated in the same color across the six frames. For example, the keypad regions 126 may illuminate with white light.

Referring to FIGS. 1-22 generally, it is recognized that the keypad illumination options provided on an electronic lock may improve a user experience significantly by expanding the types of status indicators that may be effectively communicated to a user, as well as allowing changing aesthetic appearance of the keypad itself to match a selected theme or pattern defined by or selected by a user. The addition of multiple potential colors being displayed at the keypad, with different colors associated with each keypad region, provides expanded possibilities for code entry and/or wear leveling options as well.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

1. An electronic lock, comprising:
a processing unit;
a memory device storing instructions defining a plurality of presentation modes; and
a keypad comprising:
a plurality of predefined keypad regions, each predefined keypad region including:
one or more lighting elements, wherein in response to a signal from the processing unit, the one or more lighting elements illuminate the predefined keypad region in any of a plurality of colors in accordance with a selected one of the plurality of presentation modes.

2. The electronic lock of claim 1, wherein the selected one of the plurality of presentation modes is selected by the processing unit.

3. The electronic lock of claim 2, wherein the processing unit initiates one of the plurality of presentation modes based on detection of a user proximate to the keypad.

4. The electronic lock of claim 2, wherein the processing unit initiates one of the plurality of presentation modes based on input at the keypad.

5. The electronic lock of claim 1, wherein the selected one of the plurality of presentation modes is a status message presentation mode.

6. The electronic lock of claim 5, wherein, in the status message presentation mode, the one or more lighting elements illuminate the plurality of predefined keypad regions to display an indication of a battery level of the electronic lock.

7. The electronic lock of claim 5, wherein, in the status presentation mode, the one or more lighting elements illuminate the plurality of predefined keypad regions to display an indication that an actuation passcode entered at the keypad is valid.

8. The electronic lock of claim 1, wherein the selected one of the plurality of presentation modes is a passcode input presentation mode,
wherein, in the passcode input presentation mode, the one or more lighting elements illuminate the predefined keypad region to display a plurality of colors associated with a plurality of numbers, and
wherein the association of the plurality of colors and the plurality of numbers is random.

9. The electronic lock of claim 1, wherein the selected one of the plurality of presentation modes is an ornamental presentation mode.

10. The electronic lock of claim 1, wherein the predefined keypad regions comprise predefined regions of a touch interface.

11. The electronic lock of claim 1, wherein the plurality of presentation modes is customizable by a user, wherein a definition of one or more of the plurality of presentation modes is received from a mobile device at the electronic lock via a wireless communication interface, and
wherein the selected one of the plurality of presentation modes is selected by the user at the mobile device communicatively connected to the electronic lock.

12. The electronic lock of claim 1, wherein the one or more lighting elements further illuminate the predefined keypad region in a pattern in accordance with the selected one of the plurality of presentation modes.

13. The electronic lock of claim 1, wherein the signal from the processing unit is received by the one or more lighting elements through a chain of lighting elements.

14. A method for illuminating a keypad having a plurality of predefined keypad regions, the method comprising:
selecting a presentation mode from among a plurality of stored presentation modes;
sending one or more signals from a processing unit to one or more lighting elements based on the selected presentation mode; and
illuminating one or more predefined keypad regions of the plurality of predefined keypad regions in any of a plurality of colors with the one or more lighting elements based on the received one or more signals.

15. The method of claim 14, wherein one or more signals are further based on a status of an electronic lock.

16. The method of claim 15, wherein the status of the electronic lock is a battery level of the electronic lock.

17. The method of claim 14, wherein selecting the presentation mode from the plurality of stored presentation modes includes:
detecting a user proximate to the keypad; and
selecting a presentation mode based on detecting the user proximate to the keypad.

18. The method of claim 14, wherein selecting the presentation mode from the plurality of stored presentation modes includes:
receiving an input at the keypad; and
selecting a presentation mode based on the received input.

19. A system for managing electronic lock settings, the system comprising:
an electronic lock, including:
a processing unit;
a memory device storing instructions defining a plurality of presentation modes; and
a keypad comprising:
a plurality of predefined keypad regions, each predefined keypad region including:
one or more lighting elements, wherein in response to a signal from the processing unit, the one or more lighting elements illuminate the predefined keypad region in any of a plurality of colors in accordance with a selected one of the plurality of presentation modes; and
a computing device, including:
a processor; and
a memory device storing instructions that when executed by the processor cause the computing device to execute an electronic lock application, wherein the electronic lock application includes options for customizing at least one of the plurality of presentation modes.

20. The system of claim 19, wherein the computing device is a mobile device having a wireless communication interface and the electronic lock has a wireless communication interface, and wherein the electronic lock application is a mobile application.
